(19) United States
(12) Patent Application Publication
(10) Pub. No.: US 2015/0175433 A1
(43) Pub. Date: Jun. 25, 2015

(54) CORROSION CONTROL IN AMMONIA EXTRACTION BY AIR SPARGING

(71) Applicant: INVISTA NORTH AMERICA S.A R.L., Wilmington, DE (US)

(72) Inventors: Thomas A. Micka, West Grove, PA (US); Martin J. Renner, Hallettsville, TX (US)

(73) Assignee: INVISTA NORTH AMERICA S.A R.L., Wilmington, DE (US)

(21) Appl. No.: 14/415,167

(22) PCT Filed: Jun. 24, 2013
(86) PCT No.: PCT/US2013/047349

§ 371 Date: Jan. 16, 2015

Related U.S. Application Data
(60) Provisional application No. 61/673,495, filed on Jul. 19, 2012.

(51) Int. Cl. C01C 1/12; B01D 53/18

(52) U.S. Cl. CPC C01C 1/12; B01D 53/18

(57) ABSTRACT

The present invention relates to reduction of corrosion. The present invention includes a method of decreasing corrosion during ammonia extraction. The method includes performing a process to extract ammonia using ammonia extraction equipment. The ammonia extraction equipment includes an ammonia absorber, an ammonia desorber, and an aqueous solution. The aqueous solution includes an acid or an ammonium salt thereof. The method also includes sparging an oxygen-containing gas into the solution in the ammonia absorber, the ammonia desorber, or therebetween. The invention also provides a system that can perform the method.

### CROSS-REFERENCE TO RELATED APPLICATION

This application claims benefit of priority from U.S. Provisional Application No. 61/673,495 filed Jul. 19, 2012. This application hereby incorporates by reference this application in its entirety.

### BACKGROUND OF THE INVENTION

Large-scale use of corrosive materials such as acids can be an essential part of many industrial procedures. Corrosion can lead to significant decreases in the useful lifespan of equipment in many technical areas. In some examples, the shortening of lifespan can be so severe that equipment repairs or replacement can form a major portion of long-term operational costs. One example of corrosive materials used in large-scale procedures is the use of aqueous acids to extract ammonia.

The Andrussow process generates hydrocyanic acid (HCN) from methane and ammonia in the presence of oxygen and a platinum catalyst. It is economical to operate the Andrussow HCN with recovery and recycle of unreacted ammonia, using an aqueous acid sorption loop to absorb ammonia from the reactor effluent stream. The acid can be a mineral acid such as phosphoric acid, which can extract ammonia gas by capturing it as an ammonium salt such as ammonium phosphate in an absorber. The ammonia can be liberated from the aqueous solution by heating in a stripper. Equipment that makes contact with the acid, including the absorber, stripper, and associated transfer piping, can experience high rates of corrosion. The elevated temperatures that occur in certain areas of the equipment, such as in the stripper and the associated reboiler, can exacerbate the corrosive effect.

Use of a corrosion-resistant material can reduce the rate of corrosion of the equipment. Examples of corrosion-resistant materials can include superalloys, such as nickel-copper alloys containing small amounts of iron and trace amounts of other elements such as Monel® 400, precipitation-strengthened nickel-iron-chromium alloys such as Incoloy® brand alloys, for example Incoloy® 800 series, or austenitic nickel-chromium-based Inconel® brand alloys, or nickel-chromium-molybdenum alloys such as Hastelloy® brand alloys, for example, Hastelloy® G-30®, or zirconium such as Zr 702, or super duplex stainless steel, for example 2507 or 2205. However, the cost of equipment made with corrosion-resistant materials can significantly exceed the cost of equipment fabricated using more affordable and conventional materials such as austenitic stainless steels, such as 316L.

### SUMMARY OF THE INVENTION

The present invention provides a method of decreasing corrosion during ammonia extraction. The method includes performing a process to extract ammonia using ammonia extraction equipment. The ammonia extraction equipment includes an ammonia absorber, an ammonia desorber, and an aqueous solution. The aqueous solution includes an acid or an ammonium salt thereof. The method also includes sparging an oxygen-containing gas into the solution in the ammonia absorber, the ammonia desorber, or therebetween.

The present invention can provide certain advantages over other methods of corrosion reduction. The corrosion reduction that occurs in embodiments of the present invention is a surprising advantage. Oxygen is commonly understood to contribute to the corrosion of metals via oxidative chemical mechanisms. For example, the dissolved oxygen in aqueous liquids is generally thought to cause corrosion of metals, especially in heated water. Some industries that experience aqueous liquid-related corrosion use significant resources and energy to remove oxygen in an effort to reduce corrosion. For example, the reduction of oxygen in aqueous liquids via the use of heat, vacuum pressure, steam sparging, oxygen scavengers, or via the use of other degassing methods prior to the heating of water in a large or expensive piece of corrosion-prone equipment such as a boiler unit in a steam plant is a common industry practice. Therefore, it is counter-intuitive that the addition of oxygen to an aqueous solution would reduce corrosion. Similarly, it is counter-intuitive that the addition of oxygen to the already corrosive environment of an aqueous solution containing an acid or a salt thereof would reduce corrosion. Considering that oxygen corrosion in aqueous liquids is considered to be an even larger hazard when the liquid is heated, it is even more counter-intuitive that addition of oxygen to a heated aqueous solution would lead to a reduction in corrosion. Embodiments of the present invention provide an ammonia extraction process that can use an austenitic stainless steel, such as for example 304 or 316, as a safe, reliable, and long-lasting material of construction. The gas sparging of embodiments of the present invention can be less costly and more efficient than the use of expensive and exotic corrosion-resistant materials. In addition, embodiments of the present invention can provide an ammonia extraction process that can use a corrosion-resistant material that experiences less corrosion than similar ammonia extraction processes that don't include the gas sparging described herein. Suprisingly, in some embodiments the gas sparing of the present invention can work well to reduce corrosion despite the absence of carbamate salts or ions. Surprisingly, the gas sparging of the present invention can work well to reduce corrosion in the acidic environment of an ammonia absorber. Sparging can provide an advantageous delivery method of a gas to an ammonia recovery system.

The present invention provides a system for extracting ammonia under less severe conditions, thus decreasing corrosion. The ammonia extraction equipment includes an ammonia absorber, an ammonia desorber, and an aqueous solution. The aqueous solution includes an acid or an ammonium salt thereof. The system also includes a gaseous stream containing ammonia. In the ammonia absorber at least part of the ammonia in the gaseous stream is converted into an ammonium salt. In the ammonia desorber at least part of the ammonium salt is converted into ammonia. The aqueous solution is circulated between the absorber and the desorber. The system also includes a gas sparger. The gas sparger charges oxygen-containing gas into the aqueous solution in at least one of the ammonia absorber, the ammonia desorber, and associated equipment including piping.

The present invention provides a method of decreasing corrosion during ammonia extraction. The method includes performing a process to recover unreacted ammonia from a gaseous reactor effluent stream from a chemical process. The chemical process from which ammonia is recovered is an Andrussow process to generate hydrogen cyanide. The ammonia recovery process is performed using ammonia recovery equipment. The ammonia recovery equipment includes an ammonia absorber. The ammonia recovery equipment also includes an ammonia desorber. The ammonia desorber includes an ammonia stripper tower and an ammonia stripper tower reboiler. The ammonia recovery equipment also includes an aqueous solution comprising an acid or an ammonium salt thereof. The aqueous solution is circulated between the absorber and the desorber. In the ammonia absorber at least part of the ammonia in the gaseous stream is converted into an ammonium salt. In the ammonia desorber at least part of the ammonium salt is converted into ammonia. The method also includes sparging an oxygen-containing gas into the aqueous solution in the ammonia desorber or a reboiler for the desorber. The sparging is sufficient to reduce corrosion of the desorber or the reboiler. The gas sparging into the aqueous solution occurs at a rate sufficient to maintain a rate of oxygen sparging into the solution at about 1 scf for every about 500 lbs to about 5000 lbs of the aqueous solution that flow from the desorber to the absorber.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates an ammonia recovery system, in accordance with various embodiments.

FIG. 2 illustrates an ammonia recovery system, in accordance with various embodiments.

FIG. 3 illustrates chromium concentration over time, in accordance with various embodiments.

FIG. 4 illustrates chromium concentration over time, in accordance with various embodiments.

### DETAILED DESCRIPTION OF THE INVENTION

Reference will now be made in detail to certain claims of the disclosed subject matter, examples of which are illustrated in the accompanying drawings. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.1% to 0.5%, 1.1% to 2.2%, 3.3% to 4.4%) within the indicated range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### DEFINITIONS

The term “about” can allow for a degree of variability in a value or range, for example, within 10%, within 5%, or within 1% of a stated value or of a stated limit of a range. When a range or a list of sequential values is given, unless otherwise specified any value within the range or any value between the given sequential values is also disclosed.

As used herein, “substantially” refers to a majority of, or mostly, as in at least about 50%, 60%, 70%, 80%, 90%, 95%, 96%, 97%, 98%, 99%, 99.5%, 99.9%, 99.99%, or at least about 99.999%.

The term “set” as used herein refers to standard cubic feet. “Seth” refers to standard cubic feet per hour.

The term “air” as used herein refers to a mixture of gases with a composition approximately identical to the native composition of gases taken from the atmosphere, generally at ground level. In some examples, air is taken from the ambient surroundings. Air has a composition that includes approximately 78% nitrogen, 21% oxygen, 1% argon, and 0.04% carbon dioxide, as well as small amounts of other gases.

The term “room temperature” as used herein refers to ambient temperature, which can be, for example, between about 15° C. and about 28° C.

The term “gas” as used herein includes a vapor.

The term “sparge” as used herein refers to the injection of a gas into a liquid, such that the gas contacts the liquid.

The term “absorb” or “absorption” as used herein refers to dissolution of a gas in a liquid or conversion of a gas to a soluble or insoluble salt in a liquid.

The term “desorb” or “desorption” as used herein refers to the conversion of gas that is dissolved in a liquid to gas that is no longer dissolved in the liquid, or to the conversion in a liquid of a soluble or insoluble salt of the compound to be desorbed into the desorbed compound. In one example, the soluble or insoluble salt is an ammonium salt, and the compound to be desorbed is ammonia.

The term “absorber” as used herein refers to one or more pieces of equipment that absorb or extract one or more compounds from a gas, vapor, or liquid, into a liquid. The absorbed or extracted compound or compounds can be dissolved in the absorbing liquid, or can be in the form of another compound in the absorbing liquid, such as a soluble or insoluble salt of the compound that is absorbed. In one example, the soluble or insoluble salt is an ammonium salt, and the compound to be absorbed is ammonia.

The term “desorber” as used herein refers to one or more pieces of equipment that desorb one or more compounds from a liquid, such as that desorb one or more gases from a liquid. The one or more compounds can be dissolved in the liquid, or can be absorbed in the liquid in the form of a soluble or insoluble salt of the compound to be desorbed. In one example, the soluble or insoluble salt is an ammonium salt, and the compound to be desorbed is ammonia. Heat can be used to desorb the one or more compounds from the liquid. Pressure differences or added compounds can be used to desorb the one or more compounds from the liquid. Any suitable method or combination of methods can be used to desorb the one or more compounds from the liquid.

The term “reboiler” as used herein refers to a heat transfer unit used for heating a liquid. A reboiler can be present near the bottom of a tower, and supplies heat to the contents of the tower, such that the tower can be used for separation purposes, such as stripping (e.g. desorption) or distillation.

The term “transfer piping” as used herein refers to materials and equipment, such as pipes, pumps, and other equipment, which contact an aqueous liquid or vapor as it is transferred from one piece of equipment to another, such as between a reboiler and a stripper tower, between a stripper tower and an absorber tower, or between a stripper tower and a condenser.

The term “corrosion” as used herein refers to the disintegration of a material due to chemical reactions with its surroundings.

The term “passivated layer” as used herein refers to a shielding outer layer, e.g. of protective corrosion or of other corrosion-resistant material, which can create a shell that protects against deeper more destructive corrosion. For example, a passivated layer can be a layer of metal oxide or nitride that shields the underlying material from destructive corrosion. In another example, a passivated layer can be a layer of a compound including a combination of one or more metal atoms with a suitable number of counterions or covalently bonded moieties. A passivated layer can be made of any suitable material.

The term “mil” as used herein refers to a thousandth of an inch, such that 1 mil=0.001 inch.

The present invention provides a method of decreasing corrosion during ammonia extraction. The present invention also provides a system that can perform the method. The present invention solves the technical problem of excessive corrosion during ammonia extraction by sparging a gas that includes oxygen into the aqueous solution used to extract the ammonia.

### Ammonia Extraction Equipment.

The ammonia extraction equipment can include any suitable ammonia extraction equipment. The ammonia extraction equipment includes an ammonia absorber, an ammonia desorber, and an aqueous solution. For example, the ammonia extraction equipment can include at least one of an ammonia sorption tower, ammonia sorption tower top, ammonia sorption tower bottom, ammonia stripper tower, ammonia stripper tower top, ammonia stripper tower bottom, stripper tower reboiler, ammonia condenser, distillation column, ammonia enricher, heat exchanger, and transfer piping for each piece of equipment present. The transfer piping can include, for example, pipes or equipment. The transfer piping can include any materials that contact the aqueous solution as it flows between various pieces of equipment. The ammonia extraction equipment can be industrially sized.

The ammonia extraction equipment extracts ammonia from a feed stream. The feed stream can be in any suitable form, such as a gas, vapor, liquid, or combination thereof. The feed stream can include water, or the feed stream can be substantially free of water. An ammonia feed stream with a particular composition can be in different forms depending on the temperature and pressure of the feed stream. For example, a high pressure or chilled feed stream can include materials in a liquid state, whereas the feed stream with a substantially identical composition under lower pressure or higher temperature can include materials in a gaseous state. The extraction equipment can extract any suitable number of components from the feed stream. The ammonia feed stream can have any suitable composition, and can contain any suitable amount of ammonia and other gases. For example, the ammonia feed stream can be about 1 wt %, 2, 5, 10, 20, 30, 40, 50, 60, 70, 80, 90, 95, 98, or about 99 wt % ammonia. The ammonia feed stream can include ammonia and hydrogen cyanide. For example, the ammonia feed stream can be about 1 wt %, 2, 5, 10, 20, 30, 40, 50, 60, 70, 80, 90, 95, 98, or about 99 wt % hydrogen cyanide.

The ammonia feed stream that is extracted by the ammonia extraction equipment can originate from any suitable source. For example, the ammonia feed stream can originate from a hydrogen cyanide production process, a fertilizer production process, a wastewater purification process, an ammonia production process, a pollution prevention process, a fossil fuel combustion process, a coke manufacture process, a livestock management process, or a refrigeration process. The ammonia feed stream can include unreacted ammonia from a hydrogen cyanide generation process. The ammonia extraction equipment can recover ammonia from an Andrussow process for generating hydrogen cyanide, wherein methane and ammonia are allowed to react with oxygen in the presence of a platinum group catalyst to give hydrogen cyanide and water.

The ammonia extraction equipment uses the aqueous solution to extract the ammonia. During the extraction, the aqueous solution contacts at least part of the inside of the equipment, and is circulated therein between an ammonia absorber and an ammonia desorber via transfer piping disposed therebetween. The ammonia is absorbed into the aqueous solution either as a dissolved gas or as an ammonium salt, and is then liberated from the aqueous solution in the desorber. The liberated ammonia can be condensed. The ammonia is not condensed, or is only partially condensed. The recovered ammonia can be reused in the chemical reaction or process from which it was recovered, such as in an Andrussow process for generation of HCN, it can be used in other reactions, or it can be sold as a valuable byproduct. Portions of the aqueous solution can be removed during the extraction. The removed solution can be treated and returned to the extraction equipment, or can be treated or separated to recover the one or more ammonium salts therein which can optionally be purified and can be sold as a valuable byproduct, such that an ammonium salt is recovered.

The ammonia absorber can be any suitable ammonia absorber. The ammonia absorber absorbs ammonia from the ammonia feed stream into the aqueous solution. The ammonia absorber can absorb any suitable amount of ammonia from the ammonia feed stream, e.g., about 1 wt %, 2, 5, 10, 20, 30, 40, 50, 60, 70, 80, 90, 95, 98, 99, 99.5, 99.9, 99.99, or about 100 wt % of the ammonia in the ammonia feed stream can be absorbed into the aqueous solution in the ammonia absorber. The ammonia feed stream that has undergone absorption in the ammonia absorber can continue to other equipment for further processing. The further processing can include recycling at least part of the unabsorbed ammonia back to the absorber. The further processing can include the extraction of other compounds, or can include suitable treatments for release into the atmosphere.

The ammonia is absorbed in the form of a dissolved gas, or in the form of an ammonium salt, e.g. ammonium phosphate ((NH₄)₃PO₄), diammonium phosphate ((NH₄)₂HPO₄), or monoammonium phosphate ((NH₄)(H₂PO₄)). The salt is formed from ions present in the aqueous solution which may or may not be present in the form of a salt. The ammonia absorber contacts the ammonia feed stream with the aqueous solution to extract the ammonia into the aqueous solution. The contacting can occur in any suitable fashion. For example, the contacting can be counter-current contacting, wherein the ammonia feed stream and the aqueous solution move in opposite directions through the absorber, which can help to maximize contact therebetween. In some examples, the ammonia feed stream can enter the absorber near the bottom section, while the aqueous solution enters near the top section. The ammonia feed stream can move toward the top of the absorber through the aqueous solution. The aqueous solution can be liquid, vapor, or a combination thereof. The aqueous solution can move from the top section of the absorber to the bottom section of the absorber. The absorber can include functional architecture or packing material therein that increases contacting between the aqueous solution and the ammonia feed stream, which can help to maximize the amount of ammonia absorbed from the feed stream during its residence in the absorber. The absorber can be an absorption tower.

An ammonia absorber can be of any suitable design and generally operates countercurrently. Acid-risk sorbent liquid can enter the absorber tower near the top and flow downwardly. The absorber tower may contain internals to facilitate liquid-liquid contact. Examples of suitable internals are taught in Kirk-Othmer Encyclopaedia of Chemical Technology, 3^{rd} Edition, vol. 1, pp. 53-96 (John Wiley & Sons, 1978), and include trays, plates, rings and saddles, merely to name a few. An ammonia-containing gas can enter the tower near the bottom and flow upwardly, contacting the sorbent liquid countercurrently if the liquid is introduced near the top of the column. Gas and liquid flows to the absorber column are regulated to provide for efficient contacting, while flooding the column (due to excessively high liquid charge), entraining liquid in the ammonia-enriched gas (due to excessive flow of gas) or low absorption performance caused by an inadequate flow of gas to the absorption column. The choices of column length, diameter, and type of internal(s) can be determined by one of ordinary skill in the art given the throughput and purity requirements for the ammonia recycle stream. Incentive for recycling ammonia can include the cost of disposing of the used ammonia stream or to minimize the possibility of venting the ammonia to atmosphere. The ammonia can be recycled to an Andrussow process.

The resulting HCN-containing effluent stream from the ammonia absorber tower can contain, for example, between about 0 wt % and about 3 wt % ammonia, or between about 3 wt % and about 5 wt % ammonia, or between about 5 wt % and about 20 wt % ammonia.

The aqueous solution that contains the absorbed ammonia then passes via transfer piping to the desorber. The aqueous solution, or portions of the aqueous solution, can undergo any suitable treatment prior to entering the desorber. In some examples, portions of the aqueous solution can be removed between the absorber and the desorber. The removed portions can be suitably treated and returned to the aqueous solution at a suitable location, or can be permanently removed. The removed portions can be filtered.

Any suitable configuration of columns to form an ammonia absorption system is encompassed by the present invention, including, for example, one column or multiple column arrangements. Although a single column can provide the necessary contact time between the aqueous solution and the feed stream to effectively remove a desired amount of ammonia, it can sometimes be more convenient to use several columns in place of one. For example, tall or large columns can be expensive to build, house, and maintain. Any description herein of an ammonia absorber can encompass any suitable number of columns that together form the ammonia absorber. The ammonia absorber can include an absorber unit and a stripper unit, for example in embodiments that separate ammonia from an Andrussow process reaction effluent, an HCN stripper unit. The absorber unit can extract ammonia from a feed stream using the aqueous solution. The aqueous solution that enters the absorber unit can be an aqueous solution recycle stream from the desorber. The absorber allows the feed stream and the aqueous solution to separate, at least to some extent. The top stream of the absorber unit, which can contain HCN separated from the majority of the ammonia, then can pass to an HCN recovery system. The aqueous solution, which can contain residual feed stream materials including HCN can then enter the stripper unit, which heats the aqueous solution. The stripper unit allows the aqueous solution and other materials to separate, for example residual feed stream materials including residual HCN can be more fully separated from the aqueous solution in the stripper unit. Ammonia absorption can also occur in the stripper unit. The top stream of the stripper unit, which can include residual HCN or other materials, can return to the absorber unit, for example entering with the feed stream. The bottom stream of the stripper unit can then pass to the ammonia desorber.

The ammonia desorber can be any suitable desorber. The ammonia desorber desorbs ammonia from the aqueous solution. The ammonia desorber can desorb any suitable amount of ammonia from the aqueous solution, e.g. about 1 wt %, 2, 5, 10, 20, 30, 40, 50, 60, 70, 80, 90, 95, 98, 99, 99.5, 99.9, 99.99, or about 100 wt % of the ammonia in the aqueous solution can be desorbed from the aqueous solution in the ammonia desorber. The desorbed ammonia can be removed from the desorber to be further processed, for example to be condensed or pressurized into a liquid form, or to be used directly without liquification. A condenser can be used to remove water from the ammonia gas, which can render it more suitable for its intended use. Some examples can include a series of condensers, such as a condenser designed to remove water or other materials from the gas stream exiting the desorbed, and another cooler or lower pressure condenser designed to liquefy ammonia. The desorbed ammonia can be recycled to provide at least a portion of the ammonia feed for an Andrussow HCN process.

Any suitable configuration of columns to form an ammonia desorption system is encompassed by the present invention, including, for example, one column or multiple column arrangements. Although a single column can provide the necessary heating and separation of the aqueous solution and the ammonia, it can sometimes be more convenient to use several columns in place of one. Any description herein of an ammonia desorber can encompass any suitable number of columns that together form the ammonia desorber. The ammonia desorber can include an ammonia stripper unit and an ammonia enricher unit. The ammonia desorber can heat the aqueous solution to remove the ammonia therefrom. The ammonia desorber allows the ammonia to separate from the aqueous solution, to some extent. The bottom stream of the stripper unit includes aqueous solution that can be returned to the absorber. The top stream includes ammonia and aqueous solution that can be sent to the enricher unit. The enricher further heats the aqueous solution, to further remove ammonia from the aqueous solution, and to allow aqueous solution to separate from the ammonia. The bottom stream of the enricher can pass back to the stripper unit of the desorber. The top stream of the enricher contains predominantly ammonia and water vapor. The water vapor can be condensed out of the ammonia, and the ammonia can be used in any suitable fashion, such as by being recycled to be used as a starting material for an Andrussow HCN process.

The ammonia absorbed in the aqueous solution in the form of a dissolved gas or an ammonium salt is desorbed from the aqueous solution to give ammonia and the corresponding ions, which may or may not be present in the form of a salt. The ammonia desorber heats, applies vacuum pressure, or otherwise treats the aqueous solution to cause the ammonium salt to release ammonia. The treatment can occur in any suitable fashion. The desorber can be a tower, or a stripping tower. A tower can allow for better temperature control of the aqueous solution, for example as cooler aqueous solution enters the tower it can contact a smaller proportion of the liquid therein prior to becoming heated which can allow the majority of heated liquid in the tower to remain heated. Heating can occur via gas injection at the bottom of the tower, for example using any suitable gas such as air or steam, and a tower can facilitate contacting and heat transfer between the gas and the aqueous solution therein. In embodiments including the sparging of oxygen-containing gas into a stripper tower, the contacting between the gas and the aqueous solution is advantageously facilitated by a tower design. The desorber can include functional architecture or media therein that increases contacting between the aqueous solution and any gas that may be present therein, or that can increase the mixing of the aqueous solution therein, which can help to maximize the amount of ammonia desorbed from the feed stream during its residence in the desorber.

A reboiler can provide heat to the aqueous solution in the desorber. In some examples, the ammonia desorber includes a stripper tower and a stripper tower reboiler. A reboiler can be connected to a stripping tower via transfer piping at any suitable section of the tower, for example near the bottom section of the tower. The reboiler can be any suitable reboiler. The aqueous solution can be fed to the tower at any suitable section of the tower, for example near the top section of the tower. One or more pumps can be included in the transfer piping that is disposed between the stripper and the reboiler, which can circulate aqueous solution between the stripper tower and the reboiler. The rate of circulation of the liquid between the stripper and the reboiler, or the amount of heat transferred to the liquid by the reboiler, can be suitably adjusted such that an economical balance between energy use and ammonia recovery can be made. Ammonia gas and water can move to the top of the tower where it can be removed, for example via transfer piping. The aqueous solution can be removed from the desorber in any suitable location. For example, the aqueous solution can be removed from the stripper in the bottom section of the stripper, or from transfer piping between the reboiler and the stripper, or in the top section of the stripper.

The strippers herein can be of any suitable design. Generally, a stripper is similar to a distillation column, and has a reboiler unit near the bottom that heats the contents. The more volatile contents leave the top of the column, and the less volatile contents leave the bottom of the tower. The stripper tower can contain internals to facilitate chemical reactions and multiple equilibriums between gas and liquid phase. Examples of suitable internals are taught in Kirk-Othmer Encyclopaedia of Chemical Technology, 3^{rd} Edition, vol. 1, pp. 53-96 (John Wiley & Sons, 1978), and include trays, plates, rings and saddles, merely to name a few. The choices of column length, diameter, and type of internal(s) can be determined by one of ordinary skill in the art given the throughput and purity requirements for the ammonia recycle stream.

The aqueous solution that has been desorbed can return via transfer piping to the absorber. The aqueous solution, or portions of the aqueous solution, can undergo any suitable treatment prior to entering the absorber. In some examples, portions of the aqueous solution can be removed between the desorber and the absorber. The removed portions can be suitably treated and returned to the aqueous solution at a suitable location, or can be permanently removed.

The pressure that occurs in any of the absorber or desorber or any component thereof can be any suitable pressure. For example, a suitable pressure can be equal to or less than 1 psig, 2 psig, 5 psig, 7 psig, 9 psig, 11 psig, 13 psig, 15 psig, 17 psig, 19 psig, 21 psig, 23 psig, 25 psig, 27 psig, 29 psig, 31 psig, 33 psig, 35 psig, 37 psig, 39 psig, 41 psig, 43 psig, 45 psig, 47 psig, 49 psig, 51 psig, 53 psig, 55 psig, 57 psig, or 59 psig or more. The temperature that occurs in any of the absorber or desorber or any component thereof can be any suitable temperature. For example, a suitable temperature can be equal to or less than 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., or 250° C. or more. The pH that occurs in any of the absorber or desorber or any component thereof can be any suitable pH, for example, the pH can be equal to or below 1, 2, 3, 4, 5, 6, 7, or about 8.

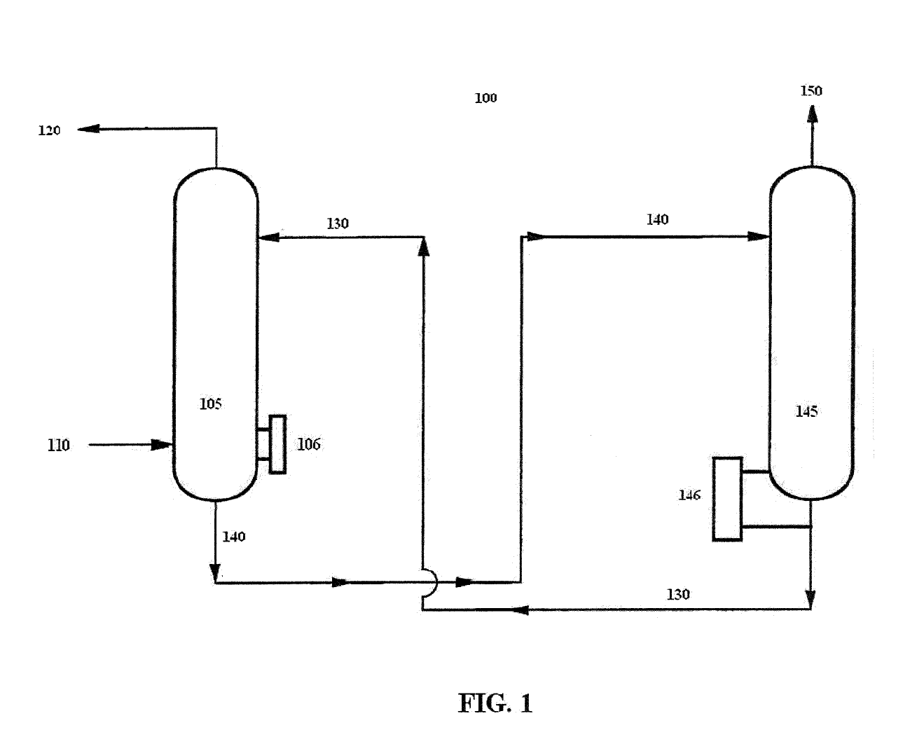

FIG. 1 illustrates an ammonia recovery system 100, in accordance with various embodiments. The feed stream 110 can be reaction effluent from an Andrussow process, and can include HCN and ammonia. The ammonia absorber can include an absorber unit 105. The ammonia absorber 105 can have a reboiler unit 106. The absorber unit 105 extracts ammonia from the feed stream 110 using the aqueous solution. The aqueous solution that enters the absorber unit 105 can be an aqueous solution recycle stream 130 from the desorber 145. The absorber allows the feed stream and the aqueous solution to separate. The top exiting stream 120 of the absorber unit 105, which can contain HCN separated from the majority of the ammonia, then can pass to an HCN recovery system (not shown). The bottom exiting stream 140 of the absorber unit 105 can then pass to the ammonia desorber 145.

Still referring to FIG. 1, the ammonia recovery system 100 includes an ammonia desorber 145. The ammonia desorber 145 can include an ammonia desorber reboiler 146. The ammonia desorber 145 can heat the aqueous solution (using reboiler 146) to remove the ammonia therefrom. The ammonia desorber 145 allows the ammonia to separate from the aqueous solution. The bottom stream 130 of the stripper unit 145 includes aqueous solution that can be returned to the absorber unit 105. The top stream 150 contains predominantly ammonia and water vapor. The water vapor can be condensed out of the ammonia, and the ammonia can be used in any suitable fashion, such as by being recycled to be used as a starting material for an Andrussow HCN process. Sparging of a gas including oxygen as described herein can occur as described herein, for example, in the bottom or lower section of the desorber 145, in the reboiler 146 of the desorber 145, or in the transfer piping in between the desorber 145 and the desorber reboiler 146.

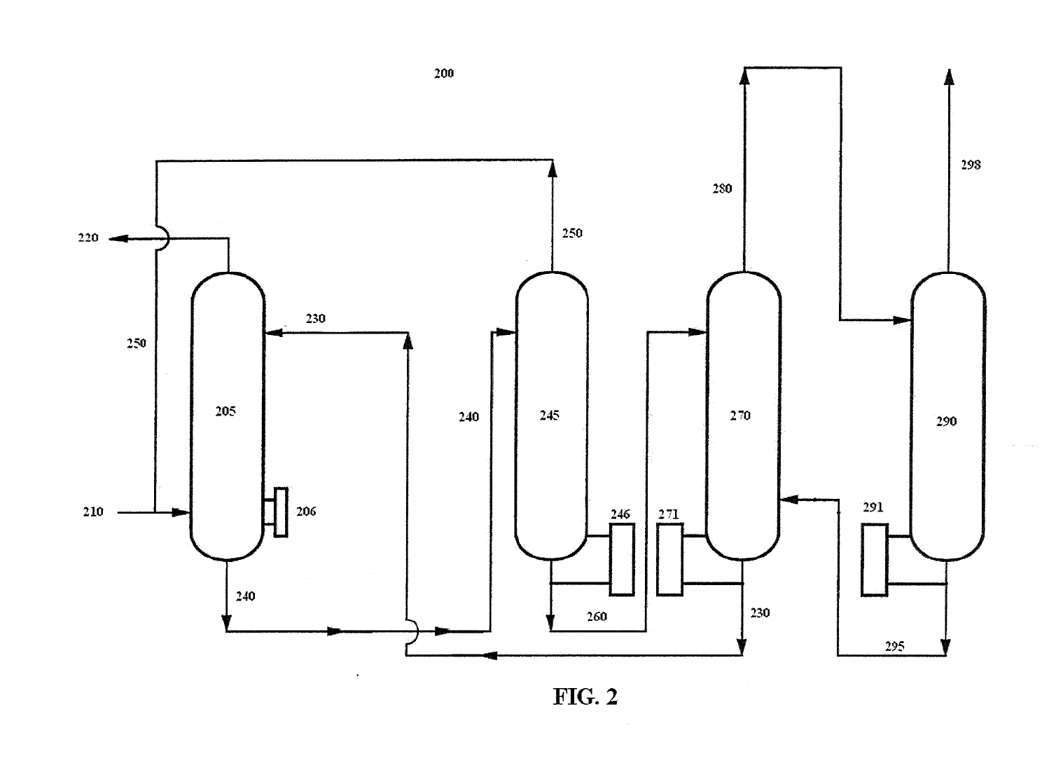

FIG. 2 illustrates an ammonia recovery system 200, in accordance with various embodiments. The feed stream 210 can be reaction effluent from an Andrussow process, and can include HCN and ammonia. The ammonia absorber can include an absorber unit 205 and a stripper unit 245. The ammonia absorber 205 can have a reboiler unit 206. The stripper unit 245 can have a reboiler unit 246. The absorber unit 205 extracts ammonia from the feed stream 210 using the aqueous solution. The aqueous solution that enters the absorber unit 205 can be an aqueous solution recycle stream 230 from the desorber stripper unit 270. The absorber allows the feed stream 210 and the aqueous solution to separate. The top stream 220 of the absorber unit 205, which can contain HCN separated from the majority of the ammonia, then can pass to an HCN recovery system (not shown). The aqueous solution 240, which can contain residual feed stream materials including HCN can then enter the stripper unit 245, which heats the aqueous solution (using reboiler 246). The stripper unit 245 allows the aqueous solution and other materials to separate, for example residual feed stream materials including residual HCN can be more fully separated from the aqueous solution in the stripper unit 245. Ammonia absorption can also occur in the stripper unit 245. The top stream 250 of the stripper unit 245, which can include residual HCN or other materials, can return to the absorber unit 205, for example entering with the feed stream 210. The bottom stream 260 of the stripper unit 245 can then pass to the ammonia desorber stripper unit 270.

Still referring to FIG. 2, the ammonia desorber can include an ammonia stripper unit 270 and an ammonia enricher unit 290. The ammonia stripper unit 270 can have a reboiler 271. The ammonia enricher unit 290 can have a reboiler 291. The ammonia stripper 270 can heat the aqueous solution (using reboiler 271) to remove the ammonia therefrom. The ammonia stripper 270 allows the ammonia to separate from the aqueous solution. The bottom stream 230 of the stripper unit 270 includes aqueous solution that can be returned to the absorber unit 205. The top stream 280 includes ammonia and aqueous solution that can be sent to the enricher unit 290. The enricher 290 further heats the aqueous solution (using reboiler 291), to further remove ammonia from the aqueous solution, and to allow aqueous solution to separate from the ammonia. The bottom stream 295 of the enricher 290 can pass back to the stripper unit 270 of the desorber. The top stream 298 of the enricher 290 contains predominantly ammonia and water vapor. The water vapor can be condensed out of the ammonia, and the ammonia can be used in any suitable fashion, such as by being recycled to be used as a starting material for an Andrussow HCN process. Sparging of a gas including oxygen as described herein can occur as described herein, for example, in the bottom or lower section of the ammonia stripper unit 270, in the reboiler 271 of the ammonia stripper unit 270, or in the transfer piping in between the ammonia stripper unit 270 and the ammonia stripper unit reboiler 271.

### Aqueous Solution.

The ammonia extraction equipment includes an aqueous solution. The aqueous solution circulates between the absorber and the desorber, and is used to absorb the ammonia from the ammonia feed stream. The aqueous solution absorbs ammonia as dissolved gas, or as an ammonium salt. The aqueous solution contacts at least part of the interior of the ammonia extraction equipment, including the absorber, the desorber, and associated transfer piping. The portions of the equipment that contact the aqueous solution can experience corrosion, at least some of which is reduced by the present invention as compared to the corresponding corrosion experienced without performing sparging of oxygen-containing gas as described herein.

The aqueous solution absorbs ammonia as dissolved gas, or as an ammonium salt. The ammonium salt includes an ammonium ion and a counterion. The counterion can be provided from an acid in the aqueous solution. Alternatively, the counterion can be provided by a salt already present in the solution.

For example, the aqueous solution can include a mineral acid such as hydrochloric acid or sulfuric acid. For example, if the acid is hydrochloric acid, the ammonia can react with the hydrochloric acid upon contacting the ammonia feed stream with the aqueous solution to form ammonium chloride. In the desorber, the ammonium chloride can be converted to ammonia and hydrogen chloride.

In another example, the aqueous solution can include phosphoric acid (H₃PO₃), monoammonium phosphate ((NH₄)(H₂PO₄)) (e.g. “ammonium dihydrogen phosphate”), diammonium phosphate ((NH₄)₂(HPO₄)) (e.g. “ammonium hydrogen phosphate”), ammonium phosphate ((NH₄)₃PO₄) (e.g. “triammonium phosphate”), or any combination thereof. In the absorber, the aqueous solution can include at least one of phosphoric acid, monoammonium phosphate, and diammonium phosphate, or any combination thereof, and optionally also contains ammonium phosphate. In the desorber, the aqueous solution can include at least one of ammonium phosphate, diammonium phosphate, and monoammonium phosphate, or any combination thereof, and optionally also contains phosphoric acid. The ammonia can react with the aqueous solution upon contact with the ammonia feed stream to form ammonium salts with counterions such as (H₂PO₄)⁻¹, (HPO₄)⁻², or (PO₃)⁻³. For example, a molecule of phosphoric acid (H₃PO₃) can react with a molecule of ammonia to form a molecule of monoammonium phosphate ((NH₄)(H₂PO₄)). In another example, a molecule of monoammonium phosphate ((NH₄)₂(HPO₄)) can react with a molecule of ammonia to form a molecule of diammonium phosphate ((NH₄)₂(HPO₄)). In another example, a molecule of diammonium phosphate ((NH₄)₂(HPO₄)) can react with a molecule of ammonia to form a molecule of triammonium phosphate ((NH₄)₃PO₄). Alternatively, multiple molecules of ammonia can combine with a single molecule of phosphate salt or phosphoric acid to generate a single salt molecule. For example, two molecules of ammonia can react with a molecule of phosphoric acid to form a molecule of diammonium phosphate ((NH₄)₂(HPO₄)). In another example, two molecules of ammonia can react with a molecule of monoammonium phosphate ((NH₄)(H₂PO₄)) to form a molecule of ammonium phosphate ((NH₄)₃PO₄). In another example, three molecules of ammonia can react with a molecule of phosphoric acid (H₃PO₃) to form a molecule of ammonium phosphate ((NH₄)₃PO₄). In the desorber, the phosphate salts can be converted to ammonia and the corresponding phosphorus compounds. For example, a molecule of ammonium phosphate ((NH₄)₃PO₄) can give a molecule of ammonia and a molecule of diammonium phosphate ((NH₄)₂(HPO₄)). In another example, a molecule of diammonium phosphate ((NH₄)₂(HPO₄)) can give a molecule of ammonia and a molecule of monoammonium phosphate ((NH₄)(H₂PO₄)). In another example, a molecule of monoammonium phosphate ((NH₄)(H₂PO₄)) can give a molecule of ammonia and a molecule of phosphoric acid (H₃PO₃). Alternatively, a single molecule of ammonium salt can form a single molecule of phosphate salt or phosphoric acid and multiple molecules of ammonia. For example, a molecule of diammonium phosphate ((NH₄)₂(HPO₄)) can form a molecule of phosphoric acid (H₃PO₃) and two molecules of ammonia. In another example, a molecule of ammonium phosphate ((NH₄)₃PO₄) can form a molecule of monoammonium phosphate ((NH₄)(H₂PO₄)) and two molecules of ammonia. In another example, a molecule of ammonium phosphate ((NH₄)₃PO₄) can form a molecule of phosphoric acid (H₃PO₃) and three molecules of ammonia. One of skill in the art will readily understand that certain ions can interconvert, e.g. a proton can move between an (HPO₄)⁻² and (H₂PO₄)⁻¹ to form (H₂PO₄)⁻¹ and (HPO₄)⁻².

The aqueous solution can include sulfuric acid (H₂SO₄), ammonium bisulfate (NH₄(HSO₄)), ammonium sulfate ((NH₄)₂SO₄), or any combination thereof. In the absorber, the aqueous solution can include at least one of sulfuric acid and ammonium bisulfate, and optionally can include ammonium sulfate. In the desorber, the aqueous solution can include at least one of ammonium bisulfate and ammonium sulfate, and optionally can include sulfuric acid. In the absorber, the ammonia can combine with the acid or a sulfate salt to form a sulfate salt. For example, a molecule of sulfuric acid can combine with a molecule of ammonia to form a molecule of ammonium bisulfate. In another example, a molecule of ammonium bisulfate can combine with a molecule of ammonia to form a molecule of ammonium sulfate. In another example, a molecule of sulfuric acid can combine with two molecules of ammonia to form a molecule of ammonium sulfate. In the desorber, the sulfate salt can form ammonia and a sulfate salt or the acid. For example, a molecule of ammonium sulfate can form a molecule of ammonia and a molecule of ammonium bisulfate. In another example, a molecule of ammonium bisulfate can form a molecule of ammonia and a molecule of sulfuric acid. In another example, a molecule of ammonium sulfate can form two molecules of ammonia and a molecule of sulfuric acid.

The aqueous solution can include nitric acid or acetic acid. The ammonia can react with the acid in the absorber to generate ammonium nitrate or ammonium acetate. In the desorber, the ammonium nitrate or ammonium acetate can be converted to ammonia and the acid.

### Sparging

The method also includes sparging an oxygen-containing gas into the aqueous solution in the ammonia absorber, the ammonia desorber, the desorber reboiler, or in any suitable location therebetween. In sparging, a gas can be injected into a liquid, for example such that bubbles of the gas are formed in the liquid; alternatively, a gas can be injected directly into a gas or vapor phase wherein the solution into which sparging is occurring is raining down from above. The gas can be sparged into a small amount of liquid, such that bubbles do not form but rather the sparged gas immediately enters a gas or vapor phase. The sparging can cause oxygen from the gas that is sparged to become dissolved in the aqueous solution, or to become dispersed in the gas or vapor phase of the apparatus. A sparged gas dissolved in a liquid phase will generate a vapor pressure over the liquid. Other gases that may be present in the gas that is sparged can also become dissolved in the aqueous solution or that can enter the gas or vapor phases therein.

In embodiments wherein the sparging causes bubbles of gas to form, the bubbles can be suspended in the apparatus for short or long amounts of time. In some examples, large bubbles can break down into small bubbles (e.g. less than about 100 mm to about 1 mm diameter), which can break down into microbubbles (e.g. less than about 100 μm to about 1 μm in diameter). In other examples, the initially formed bubbles can be large bubbles, small bubbles, or microbubbles. Bubbles can break down into smaller bubbles in the apparatus, for example by action of mixing, which can be aided by the architecture of the apparatus or by packing material therein. Likewise, bubbles can combine to form larger bubbles. The gas in any bubble can become dissolved in the surrounding liquid, can remain in the bubble as a suspended bubble, or a combination thereof. Due to a greater ratio of surface area to gas volume in smaller bubbles, the rate with which gas in smaller bubbles dissolves in the surrounding aqueous solution can be greater than in larger bubbles. Once bubbles reach the top of a liquid layer in the apparatus, they can burst such that the gas contained therein becomes part of gas or vapor in the apparatus. The sparging environment can be one wherein the liquid rains down as gas moves upwards; thus bubbles can enter a gas or vapor phase shortly after being sparged into the lower section of a column.

The gas that is sparged into the aqueous solution can be sparged in any suitable fashion. For example, the gas can enter the apparatus through any suitably shaped orifice, through any suitable number of orifices, wherein the orifices can have any suitable pattern of size or pattern of distribution. Some examples of sparging equipment can include sintered metal pipes (metal sponge), a special injection spray type nozzle, or an open pie with or without a diffuser. The gas can be sparged through an apparatus shaped like a pipe with a cap, wherein the pipe has many holes in it. The pressure used for sparging in such an apparatus depends on the number and size of the holes, and is sufficient such that all or most of the holes in the pipe have gas emitting from them. The pipe can be submerged in liquid, partially submerged, or can sparge directly into a gas or vapor phase.

The gas can be sparged into the apparatus at any suitable rate. The gas can be sparged at a minimum rate, sufficient to sparge enough oxygen to obtain an anti-corrosive effect. The gas can be sparged at a maximum rate, above which anti-corrosive effects reduce or other adverse effects occur. For example, the gas mixture can be sparged into the apparatus at less than or equal to 5 scfh, 10 scfh, 100 scfh, 500 scfh, 1000 scfh, 1500 scfh, 2000 scfh, 2500 scfh, 3000 scfh, 3500 scfh, 4000 scfh, 4500 scfh, 5000 scfh, 5500 scfh, 6000 scfh, 6500 scfh, 7000 scfh, 7500 scfh, 8000 scfh, 8500 scfh, 9000 scfh, 9500 scfh, 10,000 scfh, 15,000 scfh, or 50,000 scfh or more. The flow rate of the liquid through the apparatus being sparged can be less than or equal to about 5,000 lbs/h, 10,000 lbs/h, 50,000 lbs/h, 100,000 lbs/h, 200,000 lbs/h, 300,000 lbs/h, 400,000 lbs/h, 500,000 lbs/h, 600,000 lbs/h, 700,000 lbs/h, 800,000 lbs/h, 900,000 lbs/h, 1,000,000 lbs/h, 10,000,000 lbs/h or more. In some embodiments, an amount of liquid equivalent to the total volume of liquid in the absorber/desorber loop can be fully circulated through the loop in about 0.1 h, 0.3 h, 0.5 h, 0.7 h, 0.9 h, 1 h, 1.2 h, 1.4 h, 1.6 h, 1.8 h, 2 h, 3 h, 4 h, 5 h, 10 h, or in about 24 h, as is necessary to maintain a suitable amount of ammonia scrubbing.

The composition of the gas that is sparged can be any suitable gas composition, such that it contains at least some oxygen. For example, the gas composition can be about 0.01 mol %, 0.1, 1, 2, 5, 6, 7, 8, 9, 10, 11, 12, 13, 14, 15, 16, 17, 18, 19, 20, 30, 40, 50, 60, 70, 80, 90, 95, 98, 99, 99.5, 99.9, 99.99, or about 100 mol % oxygen. In some embodiments, the gas composition can be about 1-21 mol % oxygen, or about 8-12 mol % oxygen, or about 9.5-10 mol % oxygen. The flow rate for a gas composition having a lower mol % oxygen can be greater than the flow rate for a gas composition having a higher mol % oxygen, as is suitable to maintain the corrosion reducing effect. Other gases that can be in the gas that is sparged can include nitrogen, oxygen, carbon dioxide, water vapor, hydrogen, helium, noble gases (e.g. argon), or any suitable gas. In some examples, the gas that is sparged is air, e.g. approximately 78% nitrogen, 21% oxygen, 1% argon, and 0.04% carbon dioxide, as well as small amounts of other gases. The sparged gas can be ambient air with sufficient nitrogen added such that the oxygen concentration is about 1-20 mol %, or about 5-15 mol %, or about 8-12 mol %, or about 9.5-10 mol %. The ambient air can be compressed air.

The rate of sparging of the gas can be determined based on the amount of oxygen that enters the system at the sparge rate. The amount of oxygen that enters the system can scale to the amount of liquid that is flowing through the system, e.g. the amount of aqueous solution that is flowing from the desorber to the absorber. The oxygen sparged into the system, based on the amount of aqueous solution flowing through the equipment being sparged, e.g. from the desorber to the absorber, can be less than or equal to about 1 scf oxygen/100 lbs aqueous solution, 1 scf/500 lbs, 1 scf/1000 lbs, 1 scf/1200 lbs, 1 scf/1400 lbs, 1 scf/1600 lbs, 1 scf/1800 lbs, 1 scf/2000 lbs, 1 scf/2500 lbs, 1 scf/3000 lbs, 1 scf/4000 lbs, 1 scf/5000 lbs, 1 scf/7500 lbs, or about 1 scf oxygen/10,000 lbs aqueous solution or more.

Sparging can occur at any suitable location in the ammonia extraction equipment, or in any combination of suitable locations. Sparging can occur at a single location, or in multiple locations. Sparging can occur within the absorber, within the desorber, or within the transfer piping. For example, the sparging can occur within the bottom section of an absorption tower. The sparging can occur within the top section of an absorption tower. The sparging can occur in the transfer piping between an absorption tower and a desorption apparatus, for example in the transfer piping that allows liquid to flow from the absorber to the desorber, or in the transfer piping that allows liquid to flow from the desorber to the absorber. The sparging can occur in the bottom section of a desorption tower. The sparging can occur in the top section of a desoption tower. The sparging can occur in a reboiler that is connected to a desoption tower. The sparing can occur in the transfer piping that is disposed between a reboiler and a desorption tower. The sparging can occur in the lower section of a stripping tower, in the reboiler connected to the stripping tower, or in both.

### Reduction of Corrosion.

The sparging of the oxygen-containing gas into the solution in the ammonia absorber, the ammonia desorber, or therebetween can be sufficient to reduce corrosion of the ammonia absorber or the ammonia desorber. The reduction is as compared to the process as performed without the sparging of the oxygen-containing gas, wherein with reduced corrosion the amount of corrosion per time is less. The reduction of corrosion can occur in the piece of equipment wherein sparging is performed, in a piece of equipment connected to the piece of equipment wherein sparging is performed, in transfer piping connecting the piece of equipment wherein sparging is performed to other equipment, or in any combination thereof. In one example, the piece of equipment in which sparging is performed has the greatest reduction in corrosion, as compared to a peripheral piece of equipment that also experiences a reduction in corrosion.

Corrosion is the disintegration of a material due to chemical reactions with its surroundings. Corrosion can be measured in any suitable fashion. For example, corrosion can be measured as the amount of material that is lost per period of time. The amount of material can be defined as a volume of material, or as a thickness of material. Such quantities are not necessarily equivalent, since pitting can sometimes occur, and since the thickness of material corroded may not be consistent throughout a piece of equipment. Although a volumetric measurement of material lost can be a very accurate measurement of corrosion rate, generally it is more practical and substantially as useful to measure a change in thickness per time. In some examples, a thickness change per time can be averaged over the entire corrosion-prone surface area of a piece of equipment, can be averaged over a particular section of the surface area of a piece of equipment, or can be the measure of the change of thickness of a specific part of the piece of equipment.

Corrosion can occur on surfaces of the ammonia extraction equipment that contacts the aqueous solution, or that contacts solution that condenses. The rate of corrosion can be especially severe in areas of the ammonia extraction equipment that contact heated aqueous solution. Equipment that contacts heated aqueous solution can include the desorber, such as a stripping tower, the reboiler, and the transfer piping disposed therebetween. The materials used in any of the ammonia recovery equipment can be any one or any combination of any suitable corrosion-prone or corrosion-resistant material.

The term “corrosion-prone” is used herein to designate material that is corrosion-prone as compared to specialized and generally more expensive corrosion-resistant materials, rather than as compared to materials that are generally corrosion-prone as compared to all metals such as iron or non-stainless steel (e.g. steel not having sufficient chromium to allow formation of a protective chromium-oxide barrier against corrosion). Examples of corrosion-resistant materials can superalloys, such as nickel-copper alloys containing small amounts of iron and trace amounts of other elements such as Monel® 400, precipitation-strengthened nickel-iron-chromium alloys such as Incoloy® brand alloys, for example Incoloy® 800 series, or austenitic nickel-chromium-based Inconel® brand alloys, or nickel-chromium-molybdenum alloys such as Hastelloy® brand alloys, for example, Hastelloy® G-30®. Examples of corrosion-resistant materials include any suitable corrosion-resistant material, such as super austenitic stainless steels (e.g. AL6XN, 254SMO, 904L), duplex stainless steels (e.g. 2205), super duplex stainless steels (e.g. 2507), nickel-based alloys (e.g. alloy C276, C22, C2000, 600, 625, 800, 825), titanium alloys (e.g. grade 1, 2, 3), zirconium alloys (e.g. 702), Hasteloy 276, duplex 2205, super duplex 2507, Ebrite 26-1, Ebrite 16-1, Hasteloy 276, Duplex 2205, 316 SS, 316L and 304SS, zirconium, zirconium clad 316, ferralium 255, or any combination thereof.

Corrosion-prone parts of the ammonia extraction equipment that contacts the aqueous solution can become corroded. Corrosion-prone areas include metals contacting the aqueous solution. Corrosion-prone metals can include any suitable corrosion-prone metal. For example, corrosion-prone metals can include steel, such as stainless steel. For example, corrosion-prone metals can include steel, such as stainless steel. Stainless steel can include, for example, austenitic steel, ferritic steel, martensitic steel, and combinations thereof in any suitable proportion. Stainless steels can include any suitable series of stainless steel, such as for example 440A, 440B, 440C, 440F, 430, 316, 409, 410, 301, 301LN, 304L, 304LN, 304, 304H, 305, 312, 321, 321H, 316L, 316, 316LN, 316Ti, 316LN, 317L, 2304, 2205, 904L, 1925hMo/6MO, 254SMO. Austenitic steels can include 300 series steels, for example having a maximum of about 0.15% carbon, a minimum of about 16% chromium, and sufficient nickel or manganese to retain an austenitic structure at substantially all temperatures from the cryogenic region to the melting point of the alloy. Austenitic steel can include, for example, 304 and 316 steel, such as 316L steel. The majority or entirety of a piece of equipment such as for example the absorber, desorber, and transfer piping, can be made from corrosion-prone material.

Corrosion-resistant materials can also experience corrosion, but generally the corrosion occurs at a lower rate on these materials as compared to corrosion-prone materials. The ammonia extraction equipment of the present invention can include corrosion-resistant materials on all or part of the surfaces that become corroded due to contacting the aqueous solution or vapor. The pieces of equipment that can experience the most corrosive conditions, such as the desorber, can include corrosion-resistant materials in all or some of the locations that contact the aqueous solution or vapor. The pieces of equipment that can experience less corrosive conditions, such as the absorber, can include corrosion-resistant material in all or some of the locations that contact the aqueous solution or vapor. Locations of equipment that do not contact the aqueous solution or vapor can also include corrosion-resistant materials, including areas that may be exposed to corrosive vapors, and including areas of the equipment that would be difficult to fabricate from materials that differ from the material that the rest of the particular section of the equipment is made from. Any piece of equipment can be made from a combination of corrosion-resistant and corrosion-prone materials.

In some examples, the corrosion rate with sparging can be about 1%, or about 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, or about 95% of the rate of corrosion without sparging. In some embodiments, with sparging, corrosion in the majority of areas of the ammonia absorber, desorber, reboiler, and associated transfer piping, can be about 0.1 mils/year, or about 0.5 mils/year, 1 mils/year, 2 mils/year, 3 mils/year, 4 mils/year, 5 mils/year, 10 mils/year, 15 mils/year, 20 mils/year, 25 mils/year, 30 mils/year, 35 mils/year, 40 mils/year, 45 mils/year, 50 mils/year, 55 mils/year, 60 mils/year, 65 mils/year, 70 mils/year, 75 mils/year, 80 mils/year, 85 mils/year, 90 mils/year, 95 mils/year, 100 mils/year, 105 mils/year, 110 mils/year, 115 mils/year, 120 mils/year, 125 mils/year, 130 mils/year, 135 mils/year, 140 mils/year, 145 mils/year, or about 150 mils/year. In some embodiments, the sparging can allow the corrosion rate of metals that include chromium to be lowered sufficiently such that concentration of chromium in the aqueous solution can be 1000 ppm after 90 days of operation of the recovery system, or about 900 ppm, 800 ppm, 700 ppm, 600 ppm, 500 ppm, 400 ppm, 300 ppm, 200 ppm, 100 ppm 50 ppm, 25 ppm, 10 ppm, 5 ppm, or about 1 ppm after 90 days.

### Observation or Detection of Corrosion.

Corrosion, or the degree or rate or corrosion, can be detected in any suitable manner. In one example, a visual inspection of the corrosion-prone surface can detect corrosion or the rate of corrosion. In another example, a mechanical measuring device can be used, such as a ruler or a caliper. For nondestructive testing of a general decrease in vessel wall thickness, an ultrasonic thickness gauge can be used. Examples of such gauges include the Magnaflux MT-21B thickness gauge, available from Magnaflux, 3624 W. Lake Ave., Glenview, Ill. 60026, the DeFelsko Positector UTG Standard available from DeFelsko Corporation, 802 Proctor Avenue, Ogdensburg, N.Y. 13669, and the General Tools UTEGEMTT2 ultrasonic thickness gauge, available from General Tools, 80 White Street, Suite #1, New York, N.Y. 10013. Any suitable nondestructive method of testing can be used, including, for example, ultrasound (from inside or outside), using a mold of an original wall to compare, caliper of depth gauge to measure pitting, comparison to a nearby wall (e.g. weld), x-ray, and the like.

In another example, a corrosion rate can be detected using instantaneous corrosion measurement. The instantaneous corrosion rate can be measured using techniques such as those described in Instantaneous Corrosion Rate Measurement with Small-Amplitude Potential Intermodulation Techniques Corrosion 52, 204 (1996); doi:10.5006/1.3292115, R. W. Bosch and W. F. Bogaerts, Katholieke Universiteit Leuven, Department of Metallurgy and Materials Engineering, de Croylaan 2, 3001, Heverlee, Belgium, or in U.S. Pat. No. 7,719,292 to Eden (Honeywell), “Method and apparatus for electrochemical corrosion monitoring.” In one example instantaneous corrosion measurement can be performed using a corrosion probe, such as any suitable corrosion probe. In one example, a corrosion probe can include suitable metals with an insulator therebetween, the metals being connected to an instrument which can detect corrosion. In another example, concentration of compounds produced from corrosive reactions can be measured.

### Minimum and Maximum Oxygen Concentration or Minimum and Maximum Rate of Sparging

The mechanism of corrosion reduction that occurs when performing the method of the present invention or when using the system of the present invention is not to be restricted to any particular mode or theory of operation. Any mechanism of corrosion reduction caused by the sparging is considered to be encompassed by the present invention, even if more than one different corrosion reduction mechanism may be at work between different embodiments or in a single embodiment. The corrosion reduction can be related to one variable that is related to the sparging, or the corrosion reduction can be related to multiple variables that are related to the sparging.

The sparging of the present invention can generate or sustain any suitable amount of oxygen concentration in the aqueous solution. The concentration of oxygen in the aqueous solution can be directly or indirectly related to the degree of corrosion reduction that occurs. The concentration of oxygen in the aqueous solution can be unrelated to the degree of corrosion reduction that occurs. The concentration of oxygen present in the aqueous solution or the rate at which the oxygen concentration changes can depend on the rate at which the gas is sparged into the ammonia extraction equipment. At a given rate of sparging, the concentration of oxygen in the aqueous solution of the rate of change of the concentration of oxygen can depend on the composition of the gas that is sparged, and can depend on the method of sparging, such as the number, shape, and arrangement of orifices through which the gas is sparged into the aqueous solution. The oxygen concentration can vary between a piece of equipment in which sparging is performed, and another connection piece of equipment in which no sparging is performed, wherein the oxygen concentration in the sparged piece of equipment is the highest. The oxygen concentration can be substantially the same between the connected pieces of equipment.

The oxygen concentration can vary throughout the aqueous solution in a particular piece of equipment, for example nearest the corrosion-prone surfaces compared to the bulk of the solution. The oxygen concentration can be relatively consistent throughout the aqueous solution in a particular piece of equipment. Over time the oxygen concentration can vary or oscillate between being evenly or unevenly distributed.

In embodiments having a direct or indirect relationship between oxygen concentration in the aqueous solution and the degree of corrosion-reducing effect, the relationship can be any suitable relationship. For example, once a minimum concentration has been achieved in the solution the corrosion-reducing effect can be observed, and as the concentration rises the degree of corrosion-reducing effect can vary for example linearly, exponentially, or in other inconsistent ways, such as not varying substantially. The degree of corrosion-reducing effect can vary in different ways with respect to the oxygen concentration for different concentrations. For example, at some ranges of oxygen concentration the relationship can be linear, and at other ranges the relationship can be nonlinear, exponential, or even inconsistent. The oxygen concentration can be sufficient to allow formation or sustaining of a corrosion-reducing layer, e.g. a passivated layer, on the corrosion-prone surfaces, wherein the passivated layer is sufficient to reduce the rate of corrosion of the surface where it is located. The oxygen concentration can be sufficient to allow formation or sustaining of a corrosion-ion destroying or mitigating effect.

The oxygen concentration in the aqueous solution can be maintained such that a maximum concentration is not exceeded, wherein above that maximum concentration the gas in the overhead space of the piece of equipment can have a composition that has a sufficiently high oxygen concentration to be combustible. Combustible gas compositions in the ammonia extraction equipment can be extremely hazardous, and a suitable maximum concentration can be chosen such that they are avoided. Nitrogen can be added to lower the oxygen concentration, thereby lowering the explosion risk.

The overall average oxygen concentration in the aqueous solution in the piece of equipment in which corrosion reduction occurs can be maintained above a predetermined concentration to allow the corrosion-reducing effect to occur. The minimum oxygen concentration can be any suitable minimum concentration above which corrosion reduction can occur. For example, the minimum concentration can be less than or equal to about 0.01 wt %, 0.1, 1, 2, 5, 6, 7, 8, 9, 10, 11, 12, 13, 14, 15, 16, 17, 18, 19, 20, 30, 40, or about 50 wt % oxygen.

The overall average oxygen concentration in the aqueous solution in the piece of equipment in which corrosion reduction occurs can be maintained below a predetermined concentration to allow the corrosion-reducing effect to occur. The maximum oxygen concentration can be any suitable maximum concentration below which corrosion reduction can occur. For example, the maximum concentration can be about 1 wt %, 2, 5, 6, 7, 8, 9, 10, 11, 12, 13, 14, 15, 16, 17, 18, 19, 20, 30, 40, 50, 60, 70, 80, 90, 95, 98, 99, 99.5, 99.9, 99.99, or about 100 wt % oxygen.

The sparging of the present invention can occur with any suitable rate of gas flow into the aqueous solution. The rate of gas flow can be directly or indirectly related to the degree of corrosion reduction that occurs. The rate of gas flow can be unrelated to the degree of corrosion reduction that occurs. The rate of gas flow can affect the oxygen concentration in the aqueous mixture. The rate of gas flow can affect that amount of agitation that occurs in the aqueous solution. For a given gas flow rate, the amount of agitation can depend on the method of sparging, such as the number, shape, and arrangement of orifices through which the gas is sparged into the aqueous solution.

The amount of agitation that occurs in the aqueous solution, as it relates to the rate of gas flow, can vary throughout the aqueous solution depending on proximity of the solution to the location of sparging (e.g. simple proximity or proximity to a vertical column of space above the sparging location through which the sparged gas flows most vigorously). The relationship between the location of sparging and the degree of agitation at a given location within in the aqueous solution can also depend on the presence of architecture or packing materials within the equipment that can cause mixing or agitation. Such architecture or packing materials can cause the amount of mixing agitation to be more evenly distributed throughout the column, for a given flow rate of sparged gas.

In embodiments having a direct or indirect relationship between sparging gas flow rate and the rate of corrosion, the relationship can be any suitable relationship. For example, once of minimum gas flow rate is used the corrosion-reducing effect can be observed, and as the gas flow rate rises the degree of corrosion-reducing effect can vary linearly, exponentially, or in other inconsistent ways, such as not varying substantially. The degree of corrosion-reducing effect can vary in different ways with respect to flow rate for different flow rates. For examples, at some ranges of flow rate the relationship can be linear, and at other ranges the relationship can be nonlinear, exponential, or even inconsistent. The flow rate can be sufficiently low to avoid causing sufficient agitation to disrupt a corrosion-reducing layer or the formation thereof, e.g. a passivated layer, on the corrosion-prone surfaces, wherein the passivated layer reduces the rate of corrosion of the surface where it is located. The flow rate can be sufficiently low to avoid prevention of temperature regulation of the piece of equipment in which the sparging is performed, or other peripheral equipment.

The gas flow rate into the aqueous solution can be maintained such that a maximum flow rate is not exceeded, wherein above that maximum concentration the gas in the overhead space of the piece of equipment can have a composition that has a sufficiently high oxygen concentration to be combustible. As discussed above, combustible gas compositions in the ammonia extraction equipment can be extremely hazardous, and a suitable maximum flow rate can be chosen such that they are avoided. An explosive mixture can be created, and the system can be operated such that an ignition source is not exposed to the gas mixture.

The average rate of gas flow can be maintained above a predetermined flow rate to allow the corrosion-reducing effect to occur. The gas flow rate can be any suitable gas flow rate above which corrosion reduction can occur. The average rate of gas flow can be maintained below a predetermined flow rate to allow the corrosion-reducing effect to occur. In such embodiments, the gas flow rate can be any suitable gas flow rate below which corrosion reduction can occur.

### Control System.

The present invention can include a control system. A control system can allow adjustment of various factors related to the sparging, such as the rate of gas flow, the composition of the sparged gas (e.g. the oxygen content or the content or other gases), or the oxygen concentration of the aqueous solution. Control systems are known in the art, and one of ordinary skill will readily appreciate that the method and system described herein are amenable to the use of any suitable control system such that corrosion-reduction occurs.

A control system can be manually operated, such that an operator makes a decision based on particular data or operating procedures and tells the controller that particular factor is to be set in a particular way. A manually set factor can be permanently set as such or can be set as such until another event occurs, for example until a set duration of time passes or another event triggers an end to the change or a new change. A manual controller could be used to maintain the oxygen concentration in the aqueous solution above a minimum concentration or below a maximum concentration, or could be used to maintain the flow rate above a suitable minimum or below a suitable maximum. For example, a visual inspection of corrosion or an instantaneous measurement of corrosion can cause an operator to adjust the oxygen concentration or flow rate such that the rate of corrosion-reduction is maintained or increased.

A control system can be automatic, such that information or data is fed to the control system and the control system maintains or modifies particular factors related to the sparging in response to the data. For example, information about the oxygen concentration, for example in the aqueous solution or in the headspace above the aqueous solution, can be fed to the controller, and the controller can adjust the composition or gas flow rate of the sparged gas such that the oxygen concentration in the aqueous solution is maintained above a suitable minimum concentration or below a suitable maximum concentration. In another example, information about the agitation within the piece of equipment being sparged can be fed to the controller, and the controller can adjust the gas flow rate of the sparged gas such that the oxygen concentration in the aqueous solution is maintained above or below suitable amounts of agitation. In another example, an operator can feed information about visually determined corrosion or corrosion rate into the controller, and in response the controller can adjust various aspects of the sparging to maintain or increase the degree of corrosion-reduction. In another example, the corrosion can be instantaneously measured and the measurements thereof can be fed to the controller, and in response the controller can adjust various aspects of the sparging to maintain or increase the degree of corrosion-reduction. Any suitable information can be fed to the controller, and in response the controller can modify aspects of the sparging or any other aspects of the operation of the ammonia extraction equipment in response to help achieve a maximized or sustained corrosion-reducing effect.

### EXAMPLES

The present invention can be better understood by reference to the following examples which are offered by way of illustration. The present invention is not limited to the examples given herein.

### General Procedure.

Absorber.

Gaseous reaction effluent from the reaction of methane with ammonia gas in the presence of oxygen and platinum catalyst, which includes primarily hydrogen cyanide and ammonia, is sent to an absorber tower. Approximately 99 wt % of the charged ammonia is removed. The reaction effluent enters the bottom section of the absorber tower, while an aqueous solution including phosphoric acid and/or ammonium phosphate salts such as monoammonium phosphate and diammonium phosphate enter the top section of the absorber tower. The absorber/desorber system is industrially sized, having a total volume of liquid of approximately 500,000 lbs, and produces scrubbed HCN having less than 1 wt % ammonia. The scrubbed gaseous reaction effluent exited the top of the absorber tower. The ammonium-salt solution exits the bottom of the absorber tower.

Desorber.

The ammonia-salt solution enters the top section of the ammonia stripper tower. The stripper tower removes ammonia from the solution by heating, causing the ammonium salt to release ammonia. The stripper tower includes a reboiler unit near the bottom of the stripper tower, which transfers heat into liquid in the stripper tower via a reboiler loop. Gas evolves from the liquid in the stripper tower exits the top section of the stripper tower. Liquid exits the bottom section of the stripper tower, to be at least partially recycled back to the absorber tower.

The absorber, desorber, and the reboiler are made primarily of austenitic stainless steels (304 and 316).

### Comparative Example 1

### No Sparging

The general procedure is followed, with no sparging of gas.

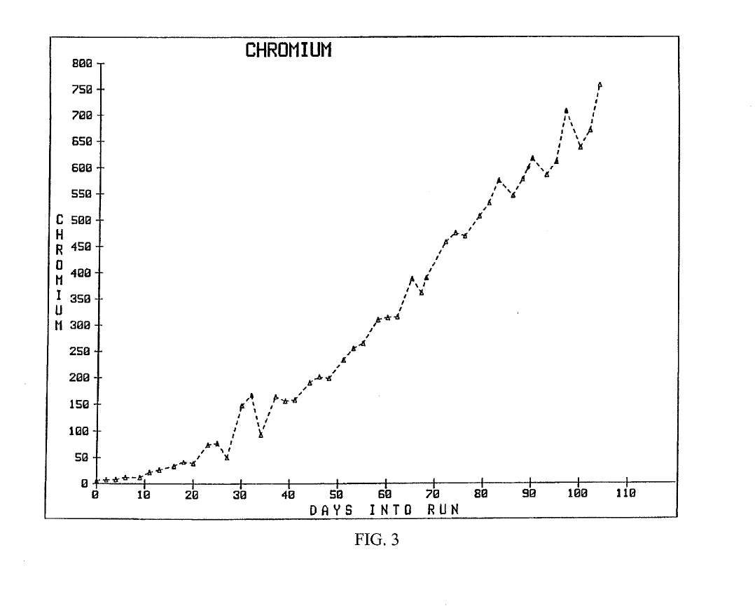

The rate of corrosion of the austenitic stainless steels in the majority of areas of the ammonia absorber, desorber, reboiler, and associated transfer piping, is approximately 0-150 mils/year, with an average of about 20-40 mils/year, with deep corrosion such as pitting occurring over localized areas, especially concentrated in the reboiler and the desorber. FIG. 3 illustrates the accumulation of chromium in the system over time. Chromium is generated when austenitic steel is corroded. The rate at which chromium builds-up is a general indication of the overall rate of corrosion of metals that include chromium. FIG. 3 shows that after about 90 days, the concentration of chromium is about 600 ppm.

### Example 1

### Sparging in Stripper Reboiler

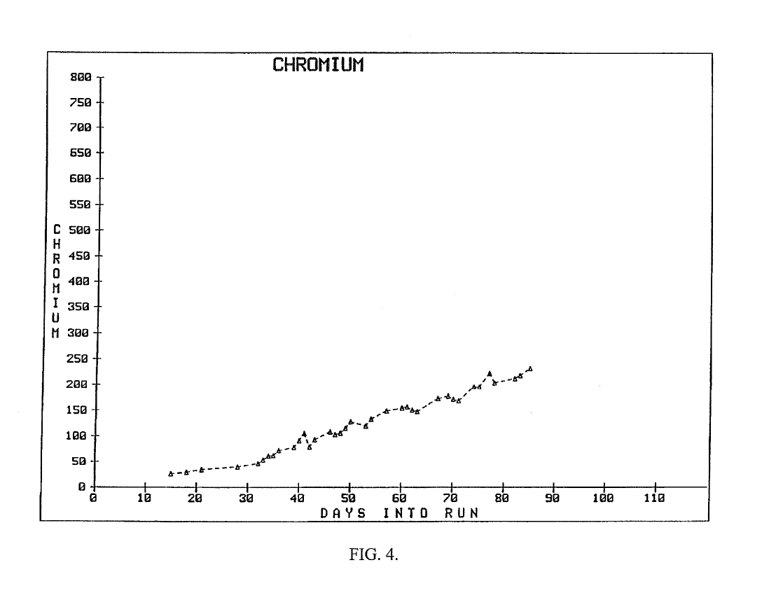

The general procedure is followed, with sparging of gas. The gas used is compressed ambient air having sufficient nitrogen added to bring the oxygen concentration to about 9 mol %. The gas is sparged into the aqueous solution in the stripper reboiler. A flow rate of about 3000 scfh of the gas is used, the gas having about 9.5-10 mole % oxygen. The rate of corrosion of austenitic stainless steels in the majority of areas of the ammonia absorber, desorber, reboiler, and associated transfer piping, is approximately 0-50 mils/year, with an average of about 5-20 mils/year, with fewer localized areas of deep corrosion such as pitting than Comparative Example 1, including particularly in the reboiler and the desorber. FIG. 4 illustrates the accumulation of chromium in the system over time. FIG. 4 shows that after about 90 days, the concentration of chromium is about 250 ppm, indicating that the corrosion rate is approximately 42% of the rate of corrosion without the air sparging.

### Example 2

### Gas Sparged into Stripper Tower

The general procedure is followed, with sparging of gas, with the gas composition and flow rate as described in Example 1. In this Example, gas is sparged into the stripper tower. The stripper tower, stripper tower reboiler, absorber, and associated transfer piping experience decreased corrosion and greater lifetime as compared to Comparative Example 1, similar to the improvement experienced in Example 1.

### Example 3a

### Gas Sparged into Stripper Tower Reboiler

The general procedure is followed, with sparging of gas, a flow rate as described in Example 1. The composition of the gas is 30 mol % oxygen in ambient air. In this Example, gas is sparged into the stripper tower reboiler. The stripper tower, stripper tower reboiler, absorber, and associated transfer piping experience decreased corrosion and greater lifetime as compared to Comparative Example 1, similar to the improvement experienced in Example 1.

### Example 3b

### Gas Sparged into Stripper Tower Reboiler

The general procedure is followed, with sparging of gas, a flow rate as described in Example 1. The composition of the gas is 1-21 mol % oxygen in ambient air, with increased flow rate for lower mol % oxygen. In this Example, gas is sparged into the stripper tower reboiler. The stripper tower, stripper tower reboiler, absorber, and associated transfer piping experience decreased corrosion and greater lifetime as compared to Comparative Example 1, similar to the improvement experienced in Example 1.

### Example 4

### Gas Sparged into Stripper Tower

The general procedure is followed, with sparging of gas, with the gas composition and flow rate as described in Example 1. In this Example, gas is sparged into the bottom of the stripper tower. The stripper tower, stripper tower reboiler, absorber, and associated transfer piping experience decreased corrosion and greater lifetime as compared to Comparative Example 1, similar to the improvement experienced in Example 1.

### Example 5

### Gas Sparged into Both Stripper Tower and Stripper Tower Reboiler

The general procedure is followed, with sparging of gas, with the gas composition and flow rate as described in Example 1. In this Example, gas is sparged into the bottom of the stripper tower and the stripper tower reboiler. The stripper tower, stripper tower reboiler, absorber, and associated transfer piping experience decreased corrosion and greater lifetime as compared to Comparative Example 1, similar to the improvement experienced in Example 1.

### Example 6

### Gas Sparged into Sorption Tower

The general procedure is followed, with sparging of gas, with the gas composition and flow rate as described in Example 1. In this Example, gas is sparged into the bottom of the absorption tower. The stripper tower, stripper tower reboiler, absorber, and associated transfer piping experience decreased corrosion and greater lifetime as compared to Comparative Example 1, similar to the improvement experienced in Example 1.

### Example 7

### Gas Sparged into Sorption Tower and Stripper Tower

The general procedure is followed, with sparging of gas, with the gas composition and flow rate as described in Example 1. In this Example, gas is sparged into the bottom of the absorption tower and the stripper tower. The stripper tower, stripper tower reboiler, absorber, and associated transfer piping experience decreased corrosion and greater lifetime as compared to Comparative Example 1, similar to the improvement experienced in Example 1.

### Example 8

### Gas Sparged into Sorption Tower, Stripper Tower, and Stripper Tower Reboiler

The general procedure is followed, with sparging of gas, with the gas composition and flow rate as described in Example 1. In this Example, gas is sparged into the bottom of the absorption tower, the stripper tower, and the stripper tower reboiler. The stripper tower, stripper tower reboiler, absorber, and associated transfer piping experience decreased corrosion and greater lifetime as compared to Comparative Example 1, similar to the improvement experienced in Example 1.

### Example 9

### Control Circuit, Sparging Based on Instantaneous Corrosion Rate Measurement

The general procedure is followed, with sparging of gas in the stripper tower reboiler, with the gas composition and flow rate as described in Example 1. In this example, a feedback loop is used that controls the air sparging rate based upon the instantaneous corrosion rate measurement. The stripper tower, stripper tower reboiler, absorber, and associated transfer piping experience decreased corrosion and greater lifetime as compared to Comparative Example 1, similar to the improvement experienced in Example 1.

### Example 10

### Control Circuit. Controller Maintains Air Flow Rates Between Lower and Upper Limit

The general procedure is followed, with sparging of gas, with the gas composition as described in Example 1. In this example, a control circuit is used to maintain the oxygen levels between about 2000 and about 7000 scfh, with an average flow rate of about 3000 scfhs. The stripper tower, stripper tower reboiler, absorber, and associated transfer piping experience decreased corrosion and greater lifetime as compared to Comparative Example 1, similar to the improvement experienced in Example 1.

### Example 11

### Extraction of Ammonia from Other Processes

The general procedure is followed, with sparging of gas, with the gas composition and flow rate as described in Example 1. In this example ammonia is extracted from a fertilizer production process, a wastewater purification process, an ammonia production process, a pollution prevention process, a fossil fuel combustion process, a coke manufacture process, a livestock management process, or a refrigeration process. In all processes, the stripper tower, stripper tower reboiler, absorber, and associated transfer piping experience decreased corrosion and greater lifetime as compared to Comparative Example 1, similar to the improvement experienced in Example 1.

### Example 12

### Other Materials

The general procedure is followed, with sparging of gas, with the gas composition and flow rate as described in Example 1. In this Example, the desorber, reboiler, and transfer piping are constructed of super austenitic stainless steels (e.g. AL6XN, 254SMO, 904L), duplex stainless steels (e.g. 2205), super duplex stainless steels (e.g. 2507), nickel-based alloys (e.g. alloy C276, C22, C2000, 600, 625, 800, 825), titanium alloys (e.g. grade 1, 2, 3), zirconium alloys (e.g. 702), Hasteloy 276, duplex 2205, super duplex 2507, Ebrite 26-1, Ebrite 16-1, Hasteloy 276, Duplex 2205, 316 SS, 316L and 304SS, zirconium, zirconium clad 316, ferralium 255, or any combination thereof. The stripper tower, stripper tower reboiler, absorber, and associated transfer piping experience decreased corrosion and greater lifetime as compared to an experiment run in accordance with the conditions of Comparative Examples 1 or 2 but constructed of the same material used in this Example as used for the equipment that is sparged, similar to the improvement experienced in Examples 1 or 2.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### Additional Embodiments

The present invention provides for the following exemplary embodiments, the numbering of which is not to be construed as designating levels of importance:

Embodiment 1 provides a method of decreasing corrosion during ammonia extraction, including: performing a process to extract ammonia using ammonia extraction equipment including an ammonia absorber, ammonia desorber, and an aqueous solution including an acid or an ammonium salt thereof; and sparging a gas including oxygen into the solution in at least one of the ammonia absorber, the ammonia desorber, and therebetween.

Embodiment 2 provides the method of Embodiment 1, wherein the sparging is sufficient to reduce corrosion of at least the ammonia desorber and a reboiler for the ammonia desorber.

Embodiment 3 provides the method of any one of Embodiments 1-2, wherein the aqueous solution is circulated between the absorber and the desorber.

Embodiment 4 provides the method of any one of Embodiments 1-3, wherein in the desorber, an ammonium salt in the solution is converted into a product mixture that includes ammonia.

Embodiment 5 provides the method of any one of Embodiments 1-4, wherein in the absorber, the ammonia is extracted from an ammonia-containing gas stream into the aqueous solution as an ammonium salt.

Embodiment 6 provides the method of any one of Embodiments 1-5, wherein the gas is sparged into the ammonia desorber.

Embodiment 7 provides the method of any one of Embodiments 1-6, wherein the ammonia desorber includes a stripper tower and a stripper tower reboiler.

Embodiment 8 provides the method of any one of Embodiments 2-7, wherein corrosion of the ammonia desorber is reduced.

Embodiment 9 provides the method of any one of Embodiments 2-8, wherein corrosion of transfer piping between the ammonia absorber and the ammonia desorber is reduced.

Embodiment 10 provides the method of any one of Embodiments 1-9, wherein the acid is phosphoric acid, sulfuric acid, hydrochloric acid, nitric acid, or acetic acid.

Embodiment 11 provides the method of any one of Embodiments 1-10, wherein the ammonium salt is monoammonium phosphate or diammonium phosphate.

Embodiment 12 provides the method of any one of Embodiments 2-11, wherein reducing the corrosion includes a reduction in rate or severity of corrosion as compared to corrosion of the corresponding equipment in an ammonia extraction process that does not include the sparging.

Embodiment 13 provides the method of any one of Embodiments 1-12, wherein the gas is air.

Embodiment 14 provides the method of any one of Embodiments 1-13, wherein a gas compressor is used to sparge the gas.

Embodiment 15 provides the method of any one of Embodiments 1-14, wherein the ammonia extraction equipment includes at least one of an ammonia absorption tower, ammonia absorption tower top, ammonia sorption tower bottom, ammonia stripper tower, ammonia stripper tower top, ammonia stripper tower bottom, stripper tower reboiler, ammonia condenser, distillation column, ammonia enricher, heat exchanger, valve, filter, and transfer piping.

Embodiment 16 provides the method of any one of Embodiments 1-15, wherein the ammonia is extracted from a gaseous or vaporous stream.

Embodiment 17 provides the method of any one of Embodiments 1-16, wherein the ammonia is extracted from a hydrogen cyanide generation process, a fertilizer production process, a wastewater purification process, an ammonia production process, a pollution prevention process, a fossil fuel combustion process, a coke manufacture process, a livestock management process, or a refrigeration process.

Embodiment 18 provides the method of any one of Embodiments 1-17, wherein the ammonia extraction process recovers unreacted ammonia from a hydrogen cyanide generation process.

Embodiment 19 provides the method of any one of Embodiments 1-18, wherein the ammonia is recovered from an Andrussow process for generating hydrogen cyanide.

Embodiment 20 provides the method of any one of Embodiments 2-19, wherein the at least one of the ammonia desorber and the reboiler for the ammonia desorber having reduced corrosion includes stainless steel.

Embodiment 21 provides the method of any one of Embodiments 2-20, wherein the at least one of the ammonia desorber and the reboiler for the ammonia desorber having reduced corrosion includes austenitic steel, ferritic steel, martensitic steel, a stainless steel series including 440A, 440B, 440C, 440F, 430, 316, 409, 410, 301, 301LN, 304L, 304LN, 304, 304H, 305, 312, 321, 321H, 316L, 316, 316LN, 316Ti, 316LN, 317L, 2304, 2205, 904L, 1925hMo/6MO, 254SMO series steel, or a combination thereof.

Embodiment 22 provides the method of any one of Embodiments 2-21, wherein the at least one of the ammonia desorber and the reboiler for the ammonia desorber having reduced corrosion includes a superalloy, nickel-copper alloy, Monel 400, precipitation-strengthened nickel-iron-chromium alloy, Incoloy brand alloy, Incoloy 800 series, austenitic nickel-chromium-based Inconel brand alloy, nickel-chromium-molybdenum alloy, Hastelloy brand alloy, Hastelloy G-30, super austenitic stainless steel, AL6XN, 254SMO, 904L, duplex stainless steel, 2205, super duplex stainless steel, 2507, nickel-based alloy, C276, C22, C2000, 600, 625, 800, 825, titanium alloy, zirconium alloy, Zr 702, Hastelloy 276, duplex 2205, super duplex 2507, Ebrite 26-1, Ebrite 16-1, Hastelloy 276, Duplex 2205, 316 SS, 316L and 304SS, zirconium, zirconium clad 316, ferralium 255, or any combination thereof.

Embodiment 23 provides the method of any one of Embodiments 2-22, wherein the at least one of the ammonia desorber and the reboiler for the ammonia desorber having reduced corrosion includes 304 or 316 austenitic steel.

Embodiment 24 provides the method of any one of Embodiments 1-23, wherein the amount of the gas sparged into the aqueous solution is sufficient to maintain a rate of oxygen sparging into the solution above a predetermined minimum rate.

Embodiment 25 provides the method of Embodiment 24, wherein the predetermined minimum rate is sufficient to allow formation, regeneration, or repair of the corrosion-reducing layer on the ammonia extraction equipment having reduced corrosion.

Embodiment 26 provides the method of any one of Embodiments 1-25, wherein the amount of the gas sparged into the aqueous solution is sufficient to maintain, regenerate, or repair a corrosion-reducing layer on the ammonia extraction equipment having reduced corrosion.

Embodiment 27 provides the method of Embodiment 26, wherein the gas is sparged into the aqueous solution in sufficiently low amount or with sufficiently low agitation such a corrosion-reducing layer on the ammonia extraction equipment having reduced corrosion is neither destroyed nor prevented from reducing corrosion.

Embodiment 28 provides the method of any one of Embodiments 1-27, wherein the gas is sparged into the aqueous solution in sufficiently low amount such that temperature control of the piece of ammonia extraction equipment into which the gas is sparged is not prevented.

Embodiment 29 provides the method of any one of Embodiments 1-28, wherein the rate of gas sparging into the aqueous solution is sufficient to maintain a rate of oxygen sparging into the aqueous solution below a predetermined maximum rate.

Embodiment 30 provides the method of Embodiment 29, wherein the predetermined maximum rate is such that the gas phase in equilibrium with the aqueous solution is non-combustible.

Embodiment 31 provides the method of any one of Embodiments 1-30, wherein the gas sparging into the aqueous solution occurs at a rate sufficient to maintain a rate of oxygen sparging into the solution at about 1 scf for every about 100 lbs to about 10,000 lbs of the aqueous solution that flow from the desorber to the absorber.

Embodiment 32 provides the method of any one of Embodiments 1-31, wherein the gas sparging into the aqueous solution occurs at a rate sufficient to maintain a rate of oxygen sparging into the solution at about 1 scf for every about 500 lbs to about 5000 lbs of the aqueous solution that flow from the desorber to the absorber.

Embodiment 33 provides the method of any one of Embodiments 1-32, further including using a controller to control the gas sparging such that a rate of oxygen sparging into the aqueous solution is maintained between a predetermined minimum rate and a predetermined maximum rate.

Embodiment 34 provides the method of Embodiment 33, wherein the sparging is sufficient to reduce corrosion of at least one of the ammonia desorber and a reboiler for the ammonia desorber, further including using the amount of corrosion that has occurred to the at least one of the ammonia absorber and the ammonia desorber having reduced corrosion to determine the predetermined minimum rate or the predetermined maximum rate.

Embodiment 35 provides the method of Embodiment 34, wherein the amount of corrosion that has occurred is determined visually, or by instantaneous corrosion rate measurement.

Embodiment 36 provides a system for extracting ammonia with decreased corrosion, including: ammonia extraction equipment including an ammonia absorber, an ammonia desorber, and an aqueous solution including an acid or an ammonium salt thereof; a gaseous stream including ammonia, wherein in the ammonia absorber at least part of the ammonia in the gaseous stream is converted into an ammonium salt, in the ammonia desorber at least part of the ammonium salt is converted into ammonia, and the aqueous solution is circulated between the absorber and the desorber; and a gas sparger that sparges gas including oxygen into the aqueous solution in at least one of the ammonia absorber, the ammonia desorber, and therebetween.

Embodiment 37 provides the system of Embodiment 36, wherein the sparging is sufficient to reduce corrosion of at least one of the absorber or the desorber.

Embodiment 38 provides the system of any one of Embodiments 36-37, further including a controller, wherein the controller controls the gas sparging such that a rate of oxygen sparging into the aqueous solution is maintained between a predetermined minimum rate and a predetermined maximum rate.

Embodiment 39 provides the system of Embodiment 38, further including a corrosion sensor, wherein the corrosion sensor measures the rate of corrosion, wherein the rate of corrosion is used to determine the predetermined minimum rate or the predetermined maximum rate.

Embodiment 40 provides a method of decreasing corrosion during ammonia extraction, including: performing a process to recover unreacted ammonia from a gaseous reactor effluent stream from an Andrussow process to generate hydrogen cyanide, wherein the process is performed using ammonia recovery equipment including an ammonia absorber, an ammonia desorber including an ammonia stripper tower and an ammonia stripper tower reboiler, and an aqueous solution including an acid or an ammonium salt thereof, wherein in the ammonia absorber at least part of the ammonia in the gaseous stream is converted into an ammonium salt, in the ammonia desorber at least part of the ammonium salt is converted into ammonia, and the aqueous solution is circulated between the absorber and the desorber; and sparging a gas including oxygen into the aqueous solution in the ammonia desorber or a reboiler of the desorber, sufficient to reduce corrosion of the desorber or the reboiler; wherein the gas sparging into the aqueous solution occurs at a rate sufficient to maintain a rate of oxygen sparging into the solution at about 1 scf for every about 500 lbs to about 5000 lbs of the aqueous solution that flow from the desorber to the absorber.

Embodiment 41 provides the apparatus or method of any one or any combination of Embodiments 1-40 optionally configured such that all elements or options recited are available to use or select from.

We claim:

1. A method of decreasing corrosion during ammonia extraction, comprising:
performing a process to extract ammonia using ammonia extraction equipment comprising an ammonia absorber, ammonia desorber, and an aqueous solution comprising an acid or an ammonium salt thereof; and
sparging a gas comprising oxygen into the solution in at least one of the ammonia absorber, the ammonia desorber, and therebetween.

2. The method of claim 1, wherein the sparging is sufficient to reduce corrosion of at least the ammonia desorber and a reboiler for the ammonia desorber.

3. The method of claim 1, wherein the aqueous solution is circulated between the absorber and the desorber.

4. The method of claim 1, wherein in the desorber, an ammonium salt in the solution is converted into a product mixture that includes ammonia.

5. The method of claim 1, wherein in the absorber, the ammonia is extracted from an ammonia-containing gas stream into the aqueous solution as an ammonium salt.

6. The method of claim 1, wherein the gas is sparged into the ammonia desorber.

7. The method of claim 1, wherein the ammonia desorber comprises a stripper tower and a stripper tower reboiler.

8. The method of claim 2, wherein corrosion of the ammonia desorber is reduced.

9. The method of claim 2, wherein corrosion of transfer piping between the ammonia absorber and the ammonia desorber is reduced.

10. The method of claim 1, wherein the acid is phosphoric acid, sulfuric acid, hydrochloric acid, nitric acid, or acetic acid.

11. The method of claim 1, wherein the ammonium salt is monoammonium phosphate or diammonium phosphate.

12. The method of claim 2, wherein reducing the corrosion comprises a reduction in rate or severity of corrosion as compared to corrosion of the corresponding equipment in an ammonia extraction process that does not include the sparging.

13. The method of claim 1, wherein the gas is air.

14. The method of claim 1, wherein a gas compressor is used to sparge the gas.

15. The method of claim 1, wherein the ammonia extraction equipment comprises at least one of an ammonia absorption tower, ammonia absorption tower top, ammonia sorption tower bottom, ammonia stripper tower, ammonia stripper tower top, ammonia stripper tower bottom, stripper tower reboiler, ammonia condenser, distillation column, ammonia enricher, heat exchanger, valve, filter, and transfer piping.

16. The method of claim 1, wherein the ammonia is extracted from a gaseous or vaporous stream.

17. The method of claim 1, wherein the ammonia is extracted from a hydrogen cyanide generation process, a fertilizer production process, a wastewater purification process, an ammonia production process, a pollution prevention process, a fossil fuel combustion process, a coke manufacture process, a livestock management process, or a refrigeration process.

18. The method of claim 1, wherein the ammonia extraction process recovers unreacted ammonia from a hydrogen cyanide generation process.

19. The method of claim 1, wherein the ammonia is recovered from an Andrussow process for generating hydrogen cyanide.

20. The method of claim 2, wherein the at least one of the ammonia desorber and the reboiler for the ammonia desorber having reduced corrosion comprises stainless steel.

21. The method of claim 2, wherein the at least one of the ammonia desorber and the reboiler for the ammonia desorber having reduced corrosion comprises austenitic steel, ferritic steel, martensitic steel, a stainless steel series comprising 440A, 440B, 440C, 440F, 430, 316, 409, 410, 301, 301LN, 304L, 304LN, 304, 304H, 305, 312, 321, 321H, 316L, 316, 316LN, 316Ti, 316LN, 317L, 2304, 2205, 904L, 1925hMo/6MO, 254SMO series steel, or a combination thereof.

22. The method of claim 2, wherein the at least one of the ammonia desorber and the reboiler for the ammonia desorber having reduced corrosion comprises a superalloy, nickel-copper alloy, Monel 400, precipitation-strengthened nickel-iron-chromium alloy, Incoloy brand alloy, Incoloy 800 series, austenitic nickel-chromium-based Inconel brand alloy, nickel-chromium-molybdenum alloy, Hastelloy brand alloy, Hastelloy G-30, super austenitic stainless steel, AL6XN, 254SMO, 904L, duplex stainless steel, 2205, super duplex stainless steel, 2507, nickel-based alloy, C276, C22, C2000, 600, 625, 800, 825, titanium alloy, zirconium alloy, Zr 702, Hastelloy 276, duplex 2205, super duplex 2507, Ebrite 26-1, Ebrite 16-1, Hastelloy 276, Duplex 2205, 316 SS, 316L and 304SS, zirconium, zirconium clad 316, ferralium 255, or any combination thereof.

23. The method of claim 2, wherein the at least one of the ammonia desorber and the reboiler for the ammonia desorber having reduced corrosion comprises 304 or 316 austenitic steel.

24. The method of claim 1, wherein the amount of the gas sparged into the aqueous solution is sufficient to maintain a rate of oxygen sparging into the solution above a predetermined minimum rate.

25. The method of claim 24, wherein the predetermined minimum rate is sufficient to allow formation, regeneration, or repair of the corrosion-reducing layer on the ammonia extraction equipment having reduced corrosion.

26. The method of claim 1, wherein the amount of the gas sparged into the aqueous solution is sufficient to maintain, regenerate, or repair a corrosion-reducing layer on the ammonia extraction equipment having reduced corrosion.

27. The method of claim 26, wherein the gas is sparged into the aqueous solution in sufficiently low amount or with sufficiently low agitation such a corrosion-reducing layer on the ammonia extraction equipment having reduced corrosion is neither destroyed nor prevented from reducing corrosion.

28. The method of claim 1, wherein the gas is sparged into the aqueous solution in sufficiently low amount such that temperature control of the piece of ammonia extraction equipment into which the gas is sparged is not prevented.

29. The method of claim 1, wherein the rate of gas sparging into the aqueous solution is sufficient to maintain a rate of oxygen sparging into the aqueous solution below a predetermined maximum rate.

30. The method of claim 29, wherein the predetermined maximum rate is such that the gas phase in equilibrium with the aqueous solution is non-combustible.

31. The method of claim 1, wherein the gas sparging into the aqueous solution occurs at a rate sufficient to maintain a rate of oxygen sparging into the solution at about 1 scf for every about 100 lbs to about 10,000 lbs of the aqueous solution that flow from the desorber to the absorber.

32. The method of claim 1, wherein the gas sparging into the aqueous solution occurs at a rate sufficient to maintain a rate of oxygen sparging into the solution at about 1 scf for every about 500 lbs to about 5000 lbs of the aqueous solution that flow from the desorber to the absorber.

33. The method of claim 1, further comprising using a controller to control the gas sparging such that a rate of oxygen sparging into the aqueous solution is maintained between a predetermined minimum rate and a predetermined maximum rate.

34. The method of claim 33, wherein the sparging is sufficient to reduce corrosion of at least one of the ammonia desorber and a reboiler for the ammonia desorber, further comprising using the amount of corrosion that has occurred to the at least one of the ammonia absorber and the ammonia desorber having reduced corrosion to determine the predetermined minimum rate or the predetermined maximum rate.

35. The method of claim 34, wherein the amount of corrosion that has occurred is determined visually, or by instantaneous corrosion rate measurement.

36. A system for extracting ammonia with decreased corrosion, comprising:
ammonia extraction equipment comprising an ammonia absorber, an ammonia desorber, and an aqueous solution comprising an acid or an ammonium salt thereof;
a gaseous stream comprising ammonia, wherein in the ammonia absorber at least part of the ammonia in the gaseous stream is converted into an ammonium salt, in the ammonia desorber at least part of the ammonium salt is converted into ammonia, and the aqueous solution is circulated between the absorber and the desorber; and
a gas sparger that sparges gas comprising oxygen into the aqueous solution in at least one of the ammonia absorber, the ammonia desorber, and therebetween.

37. The system of claim 36, wherein the sparging is sufficient to reduce corrosion of at least one of the absorber or the desorber.

38. The system of claim 36, further comprising a controller, wherein the controller controls the gas sparging such that a rate of oxygen sparging into the aqueous solution is maintained between a predetermined minimum rate and a predetermined maximum rate.

39. The system of claim 38, further comprising a corrosion sensor, wherein the corrosion sensor measures the rate of corrosion, wherein the rate of corrosion is used to determine the predetermined minimum rate or the predetermined maximum rate.

40. A method of decreasing corrosion during ammonia extraction, comprising:
performing a process to recover unreacted ammonia from a gaseous reactor effluent stream from an Andrussow process to generate hydrogen cyanide, wherein the process is performed using ammonia recovery equipment comprising an ammonia absorber, an ammonia desorber comprising an ammonia stripper tower and an ammonia stripper tower reboiler, and an aqueous solution comprising an acid or an ammonium salt thereof, wherein in the ammonia absorber at least part of the ammonia in the gaseous stream is converted into an ammonium salt, in the ammonia desorber at least part of the ammonium salt is converted into ammonia, and the aqueous solution is circulated between the absorber and the desorber; and
sparging a gas comprising oxygen into the aqueous solution in the ammonia desorber or a reboiler of the desorber, sufficient to reduce corrosion of the desorber or the reboiler;
wherein the gas sparging into the aqueous solution occurs at a rate sufficient to maintain a rate of oxygen sparging into the solution at about 1 scf for every about 500 lbs to about 5000 lbs of the aqueous solution that flow from the desorber to the absorber.
